(19) United States
(12) Patent Application Publication
(10) Pub. No.: US 2017/0291543 A1
(43) Pub. Date: Oct. 12, 2017

(54) CONTEXT-AWARE ALERT SYSTEMS AND ALGORITHMS USED THEREIN

(71) Applicant: GM Global Technology Operations LLC, Detroit, MI (US)

(72) Inventors: Claudia V. Goldman-Shenhar, Mevasseret Zion (IL); Yael Shmueli Friedland, Tel Aviv (IL); Andrew W. Gellatly, Macomb, MI (US)

(21) Appl. No.: 15/095,494

(22) Filed: Apr. 11, 2016

(51) Int. Cl. B60Q 9/00

(52) U.S. Cl. CPC B60Q 9/00

(57) ABSTRACT

A context-aware alert system including a hardware-based processing unit and a non-transitory computer-readable storage device. The storage device includes a deliberation module configured to, when executed by the hardware-based processing unit, determine a customized alert notification for use in notifying a system user of the alert condition. The notification is determined based on alert-condition input data and context-input data. The technology also includes the storage device, separately, and methods of using the system or the device are also described.

### TECHNICAL FIELD

The present disclosure relates generally to systems and algorithms for adaptively determining, based on contextual inputs, customized user notifications of an alert condition. The systems are implemented at an apparatus or machine such as at an automobile. Systems can adaptively determine a sound-file variation based on contextual inputs. In various embodiments, the system determines other customized notifications to provide based on the context, such as customized haptic or visual output, or determines recommended apparatus adjustments, such as vehicle HVAC or window adjustment.

### BACKGROUND

This section provides background information related to the present disclosure which is not necessarily prior art.

Conventional automobiles are pre-programmed with static acoustic alerts. When the vehicle determines presence of an alert condition, such as a seatbelt being unbuckled during driving, the vehicle provides an audible alert such as a chime, and/or a visual alert, such as by illuminating an instrument-panel icon illumination. The same chime or visual is provided, no matter the circumstances.

Even for vehicles that provide a different sound in connection with each of a group of related alert conditions, the alerts are still provided irrespective of any context, being distinct from the alert condition. The following chart illustrates a few examples:

| Ex. | Alert | Example | Sound |
|---|---|---|---|
| no. | Condition | Context | Output |
| I | Seat belt | Neighborhood | Sound 1 |
| | disconnected | (slower) driving | |
| II | (Same as | Highway driving | Sound 1 |
| | example I) | | (Context not |
| | | | considered) |
| III | Backing up, | Quiet environment | Sound 2 |
| | within 10 m | | |
| | of obstacle | | |
| IV | (Same as | Loud environment | Sound 2 |
| | example III) | | (Context not |
| | | | considered) |
| V | Backing up, | In-animate object | Sound 3 |
| | within 5 m | | (louder and faster |
| | of obstacle | | than sound 2) |
| VI | (Same as | Animate object | Sound 3 |
| | example V) | | (Context not |
| | | | considered) |
| VII | Backing up, | Driver paying | Sound 4 |
| | within 2 m | attention (viewing | (louder and faster |
| | of obstacle | mirror and blind | than sound 3) |
| | | spot) | |
| VIII | (Same as | Driver apparently | Sound 4 |
| | example VII) | not paying full | (Context not |
| | | attention | considered) |
| IX | Unsafe following | Clear road | Sound 5 |
| | distance | | |
| X | (Same as | Icy road | Sound 5 |
| | example IX) | | (Context not |
| | | | considered) |

In each example, the vehicle does not consider any context being distinct from the alert condition, in selecting the particular sound to provide.

If a person disconnects their seatbelt, the vehicle will deliver the same sound (Sound 1), whether the vehicle is being driven slowly, such as in a parking lot or their neighborhood, or fast on a busy highway.

If, while the vehicle is backing toward an object, a loud ambulance happens to be passing, or a baby is crying loudly, the vehicle will deliver the same sound, Sound 2, 3, or 4, based only on the proximity variable of the base alert condition, regardless of any of a wide variety of relevant context.

In the last set of examples, if a vehicle is following another vehicle too closely, the vehicle will deliver the same sound (Sound 5), whether the road is clear, icy, or otherwise.

### SUMMARY

There is a need for systems for adaptively customizing user alerts based on contextual inputs at an apparatus or machine such as at an automobile.

The present technology solves the above-referenced challenges and other needs by systems, algorithms, and processes for adaptively determining a sound-file variation based on contextual inputs. Example sound variations include increased sound level, modified sound characteristics (tone, pitch or frequency, etc.), or selection of a different sound that would otherwise be used in connection with a trigger—e.g., seatbelt unbuckled—based on context.

In various embodiments, the system determines, based on the context, other, non-sound, output to be provided at the apparatus, such as haptic or visual output, or apparatus adjustments, such as HVAC or window adjustment, to be made by the vehicle, automatically, or proposed by the vehicle to the user.

Other aspects of the present technology will be in part apparent and in part pointed out hereinafter.

### DESCRIPTION OF THE DRAWINGS

FIG. 1 illustrates schematically an example vehicle of transportation according to embodiments of the present technology.

FIG. 2 illustrates schematically an example vehicle computer in communication with remote and mobile computing systems.

FIG. 3 shows example memory components of the computer architecture of FIG. 2.

FIG. 4 shows an example algorithmic flow, based on the components of

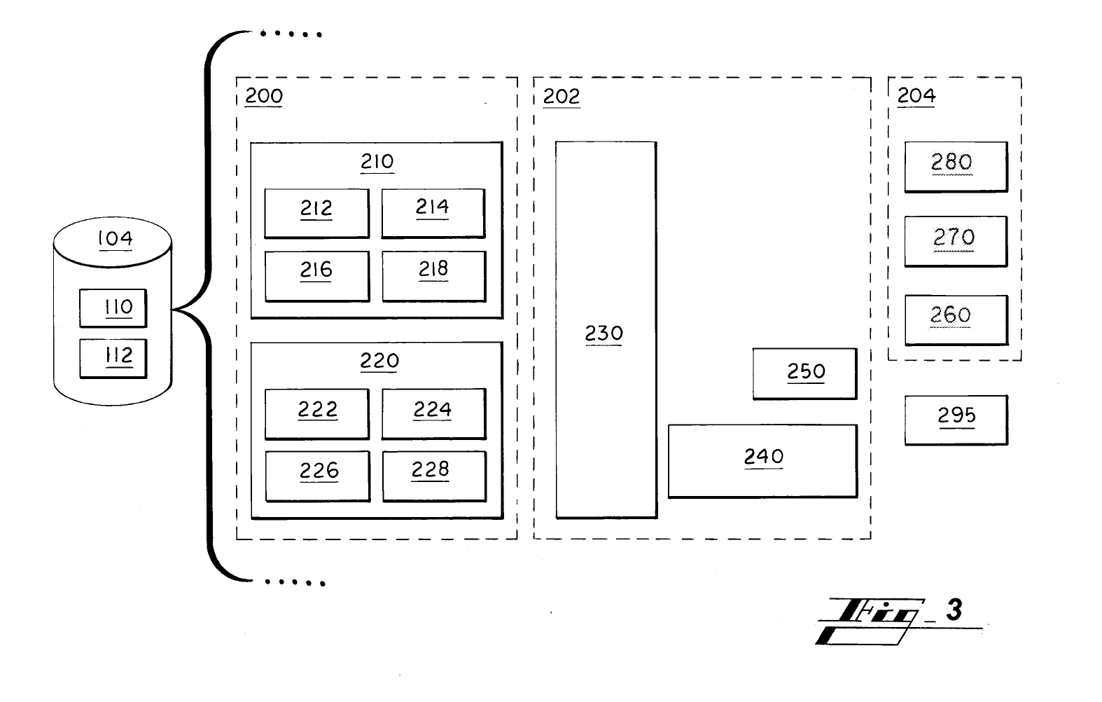

FIG. 3, for operations of the present technology.

The figures are not necessarily to scale and some features may be exaggerated or minimized, such as to show details of particular components.

### DETAILED DESCRIPTION

As required, detailed embodiments of the present disclosure are disclosed herein. The disclosed embodiments are merely examples that may be embodied in various and alternative forms, and combinations thereof. As used herein, for example, exemplary, and similar terms, refer expansively to embodiments that serve as an illustration, specimen, model or pattern.

In some instances, well-known components, systems, materials or processes have not been described in detail in order to avoid obscuring the present disclosure. Specific structural and functional details disclosed herein are therefore not to be interpreted as limiting, but merely as a basis for the claims and as a representative basis for teaching one skilled in the art to employ the present disclosure.

### I. Technology Introduction

The present disclosure describes, by various embodiments, systems and algorithms for adaptively determining a type of user notification to provide, in connection with a determined alert condition, based on contextual inputs at an apparatus or machine such as at an automobile.

Example contextual inputs, outlined more below, include but are not limited to an:
driver attention or perception;
driver physiology;
driver age;
background noise sensed;
vehicle dynamics, e.g.:
   speed
   direction
   acceleration (e.g., positive, or deceleration)
   location
traffic conditions;
road condition;
weather;
other-vehicle information, received wirelessly from another vehicle—e.g., other vehicle speed, emergency vehicle location, direction, emergency status or mode, etc.;
infrastructure information, received wirelessly from infrastructure external to the vehicle—such as regarding a nearby emergency vehicle, a road condition, traffic conditions, etc.; and
mobile-device information, or Internet of Things (IOT) information, received by wire or wirelessly from a user mobile device such as a user wearable, mobile phone, etc.—such as user temperature or other biometric data indicative of user state, internet-received data such as weather, the like, or other.

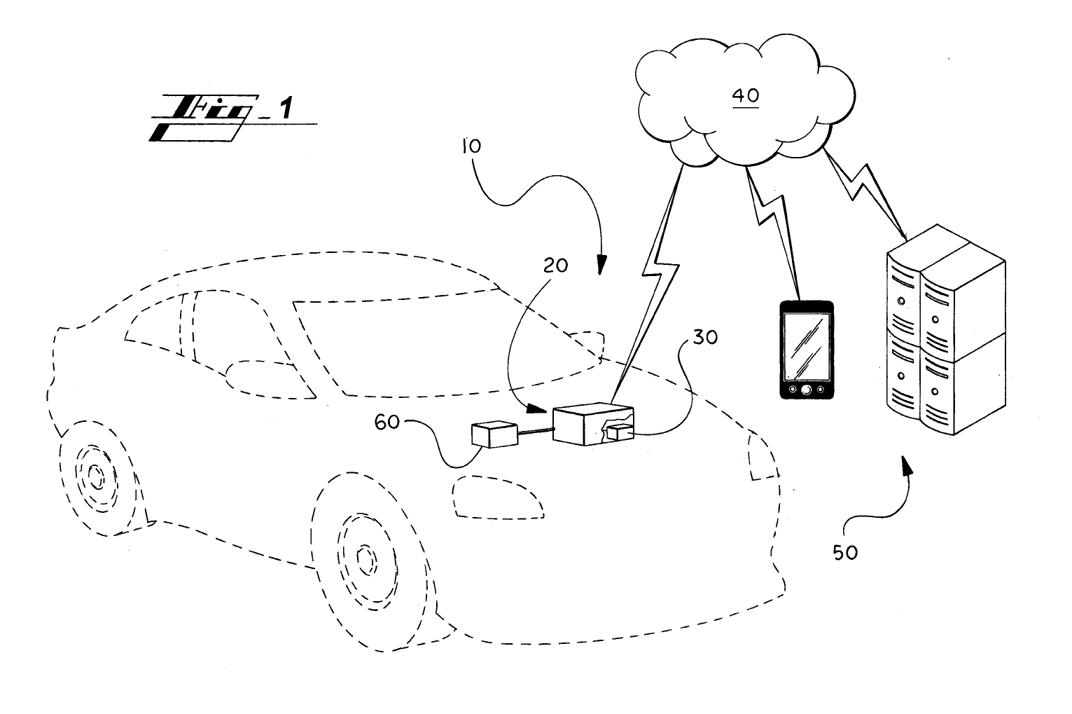

### II. Host Vehicle—FIG. 1

Turning now to the figures and more particularly the first figure, FIG. 1 shows an example host structure or apparatus or machine 10 in the form of a vehicle, and particularly an automobile.

While the present technology is described primarily with respect to vehicles, and particularly automobiles, as the host apparatus 10, the technology is not limited by the focus. The concepts can be extended to a wide variety of applications, such as aircraft, marine craft, other transportation or moving vehicles (for example, forklift), warehouse or manufacturing environments, at home, at the office, the like, and other. As other examples, the concepts can be used in the trucking industry, bussing, construction machines, or agricultural machinery.

The vehicle 10 includes a hardware-based controller or controlling system 20. The hardware-based controlling system 20 includes a communication sub-system 30 for communicating with one or more local and/or external networks 40, such as the Internet, to reach local or remote systems 50, such as servers or mobile devices.

The vehicle 10 also includes a sensor sub-system 60 comprising sensors providing information to the hardware-based controlling system 20 regarding items such as vehicle operations, vehicle position, vehicle pose, and/or an environment about the vehicle 10.

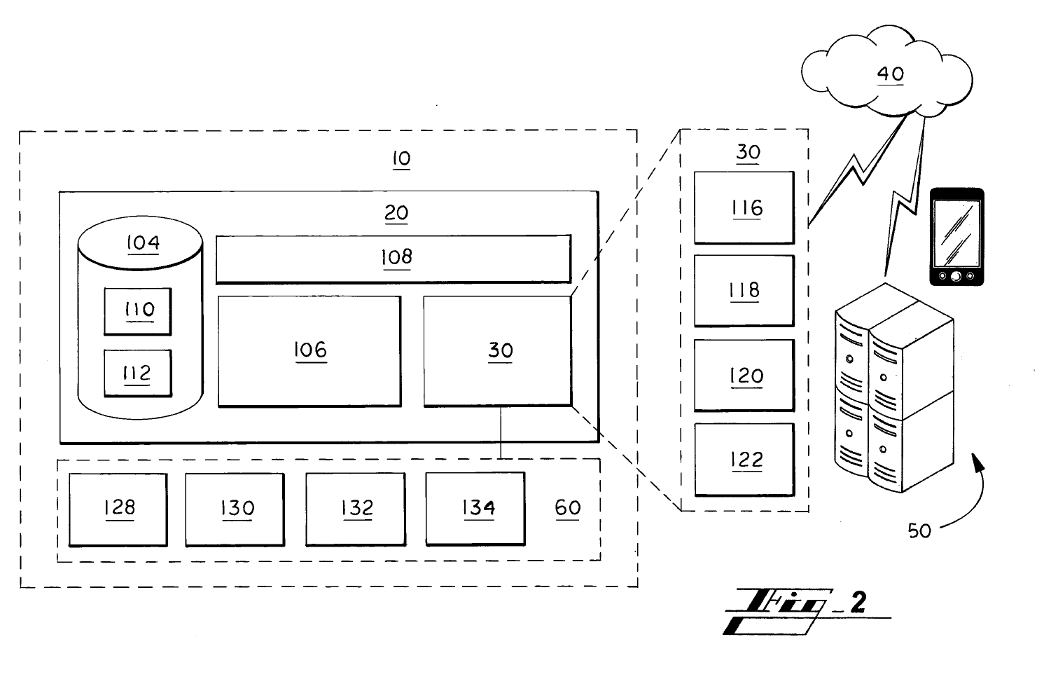

### III. On-Board Computing Architecture—FIG. 2

FIG. 2 illustrates in more detail the hardware-based computing or controlling system 20 of FIG. 1. The controlling system 20 can be referred to by other terms, such as computing apparatus, controller, controller apparatus, or such descriptive term. As mentioned, the controller system 20 is in various embodiments part of a greater system 10, such as a vehicle.

The controlling system 20 includes a hardware-based computer-readable storage medium, or data storage device 104 and a hardware-based processing unit 106. The processing unit 106 is connected or connectable to the computer-readable storage device 104 by way of a communication link 108, such as a computer bus or wireless components.

The processing unit 106 can be referenced by other names, such as processor, processing hardware unit, the like, or other.

The processing unit 106 can include or be multiple processors, which could include distributed processors or parallel processors in a single machine or multiple machines. The processing unit 106 can be used in supporting a virtual processing environment.

The processing unit 106 could include a state machine, application specific integrated circuit (ASIC), programmable gate array (PGA) including a Field PGA, or state machine. References herein to the processing unit executing code or instructions to perform operations, acts, tasks, functions, steps, or the like, could include the processing unit performing the operations directly and/or facilitating, directing, or cooperating with another device or component to perform the operations.

In various embodiments, the data storage device 104 is any of a volatile medium, a non-volatile medium, a removable medium, and a non-removable medium.

The term computer-readable media and variants thereof, as used in the specification and claims, refer to tangible storage media. The media can be a device, and can be non-transitory.

In some embodiments, the storage media includes volatile and/or non-volatile, removable, and/or non-removable media, such as, for example, random access memory (RAM), read-only memory (ROM), electrically erasable programmable read-only memory (EEPROM), solid state memory or other memory technology, CD ROM, DVD, BLU-RAY, or other optical disk storage, magnetic tape, magnetic disk storage or other magnetic storage devices.

The data storage device 104 includes one or more storage modules 110 storing computer-readable code or instructions executable by the processing unit 106 to perform the functions of the controlling system 20 described herein. The modules and functions are described further below in connection with FIGS. 3.

The data storage device 104 in some embodiments also includes ancillary or supporting components 112, such as additional software and/or data supporting performance of the processes of the present disclosure, such as one or more user profiles or a group of default and/or user-set preferences.

As provided, the controlling system 20 also includes a communication sub-system 30 for communicating with one or more local and/or external networks 40, such as the Internet, or local or remote systems 50. The communication sub-system 30 in various embodiments includes any of a wire-based input/output (i/o) 116, at least one long-range wireless transceiver 118, and one or more short- and/or medium-range wireless transceivers 120. Component 122 is shown by way of example to emphasize that the system can be configured to accommodate one or more other types of wired or wireless communications.

The long-range transceiver 118 is in some embodiments configured to facilitate communications between the controlling system 20 and a satellite and/or a cellular telecommunications network, which can be considered also indicated schematically by reference numeral 40.

The short- or medium-range transceiver 120 is configured to facilitate short- or medium-range communications, such as communications with other vehicles, in vehicle-to-vehicle (V2V) communications, and communications with transportation system infrastructure (V2I). Broadly, vehicle-to-entity (V2X) can refer to short-range communications with any type of external entity (for example, devices associated with pedestrians or cyclists, etc.).

To communicate V2V, V2I, or with other extra-vehicle devices, such as local communication routers, etc., the short- or medium-range communication transceiver 120 may be configured to communicate by way of one or more short- or medium-range communication protocols. Example protocols include Dedicated Short-Range Communications (DSRC), WI-FI®, BLUETOOTH®, infrared, infrared data association (IRDA), near field communications (NFC), the like, or improvements thereof (WI-FI is a registered trademark of WI-FI Alliance, of Austin, Tex.; BLUETOOTH is a registered trademark of Bluetooth SIG, Inc., of Bellevue, Wash.).

By short-, medium-, and/or long-range wireless communications, the controlling system 20 can, by operation of the processing unit 106, send and receive information, such as in the form of messages or packetized data, to and from the one or more communication networks 40.

External devices 50 with which the sub-system 30 communicates are in various embodiments nearby the vehicle, remote to the vehicle, or both.

An example nearby or local system 50 can include a user device such as a smartphone. Example remote systems 50 include a remote server (for example, application server), or a remote data, customer-service, and/or control center. A user device, such as a smartphone or other user computing device, can also be remote to the vehicle 10, and in communication with the sub-system 30, such as by way of the Internet 40.

An example control center is the OnStar® control center, having facilities for interacting with vehicles and users, whether by way of the vehicle or otherwise (for example, mobile phone) by way of long-range communications, such as satellite or cellular communications. ONSTAR is a registered trademark of the OnStar Corporation, which is a subsidiary of the General Motors Company.

As mentioned, the vehicle 10 also includes a sensor sub-system 60 comprising sensors providing information to the controlling system 20 regarding items such as vehicle operations, vehicle position, vehicle pose, and/or the environment about the vehicle 10. The arrangement can be configured so that the controlling system 20 communicates with, or at least receives signals from sensors of the sensor sub-system 60, via wired or short-range wireless communication links 116, 120.

In various embodiments, the sensor sub-system 60 includes at least one camera 128 and at least one range sensor 130, such as radar or sonar. The camera 128 may include a monocular forward-looking camera, such as those used in lane-departure-warning (LDW) systems. Other embodiments may include other camera technologies, such as a stereo camera or a trifocal camera.

Sensors configured to sense external conditions may be arranged or oriented in any of a variety of directions without departing from the scope of the present disclosure. For example, the cameras 128 and the range sensor 130 may be oriented at each, or a select, position of, (i) facing forward from a front center point of the vehicle 10, (ii) facing rearward from a rear center point of the vehicle 10, (iii) facing laterally of the vehicle from a side position of the vehicle 10, and/or (iv) between these directions, and each at or toward any elevation, for example.

The range sensor 130 may include a short-range radar (SRR), an ultrasonic sensor, a long-range radar, such as those used in autonomous or adaptive-cruise-control (ACC) systems, sonar, or a Light Detection And Ranging (LiDAR) sensor, for example.

Other example sensor sub-systems 60 include an inertial-momentum unit (IMU) 132, such as one having one or more accelerometers, and/or other dynamic vehicle sensors 134, such as a wheel sensor or a sensor associated with a steering system (for example, steering wheel) of the vehicle 10.

### IV. Data Structures—FIG. 3

FIG. 3 shows in more detail the data storage device 104 of FIG. 2. The components of the data storage device 104 are now described further with reference to FIG. 3.

As mentioned, the data storage device 104 includes one or more modules 110.

The data storage device 104 may also include ancillary components 112, such as additional software and/or data supporting performance of the processes of the present disclosure. The ancillary components 112 can include, for example, additional software and/or data supporting performance of the processes of the present disclosure, such as one or more user profiles or a group of default and/or user-set preferences.

The modules are shown grouped into three primary groups or modules: an input group 200, a deliberation group 202, and an output group 204, as shown in FIG. 3.

The modules 110 in various embodiments include at least eight (8) modules 210, 220, 230, 240, 250, 260, 270, 280, 290.

Any of the code or instructions described can be part of more than one module. And any functions described herein can be performed by execution of instructions in one or more modules, though the functions may be described primarily in connection with one module by way of example. Each of the modules can be referred to by any of a variety of names, such as by a term or phrase indicative of its function.

Example terms for the modules 210, 220, 230, 240, 250, 260, 270, 280 include the following:
210—Alert-condition input module
220—Contextual-input module
230—Deliberation module
240—Sound-file database module
250—Sound-file generation module
260—Sound-presentation notification module
270—Other vehicle-outputs notification module (for example, haptics, visuals)
280—Vehicle-system adjustments module (for example, HVAC, window)

FIG. 3 also shows an additional module by reference numeral 295 to indicate expressly that the controlling system 20 can include one or more additional modules. The supporting module(s) 295 can include, for example, one or more driver-account modules and/or passenger-account modules for use in creating and maintaining user accounts, which can include preferences, settings, the like, and other.

Any of the modules can include sub-modules, such as shown by reference numerals 212, 214, 216, 218, 222, 224, 226, 228 in connection with the first illustrated module group 204 of FIG. 3. Sub-modules can cause the processing hardware-based unit 106 to perform specific operations or routines of module functions. Each sub-module can also be referred to by any of a variety of names, such as by a term or phrase indicative of its function.

Example terms for the sub-modules 212, 214, 216, 222, 224, 226, include the following:
212—Seatbelt alert sub-module
214—Proximities alert sub-module
216—Vehicle-condition sub-module
222—Person-related context sub-module
224—Vehicle-related context sub-module
226—Environment-related context sub-module

FIG. 3 also shows an additional sub-module 218, 228 in each of the respective corresponding modules 210, 220 to indicate expressly that the controlling system 20 can include one or more additional sub-modules. The additional sub-module(s) need not be a part of the first two modules 210, 220. The supporting module(s) 295 can include, for example, one or more driver-account modules and/or passenger-account modules for use in creating and maintaining user accounts, which can include preferences, settings, the like, and other. The supporting modules(s) 295 could include, as other examples, a location, or geo-positioning, context module, a temporal-, scheduling-, planning-, or itinerary-context module (concerned with time of day or date, or a user schedule, itinerary, or other plan, for instance), or such sub-modules could be part of one of the enumerated sub-modules, such as the environment-related module 226.

The modules, sub-modules, and their functions are described further below.

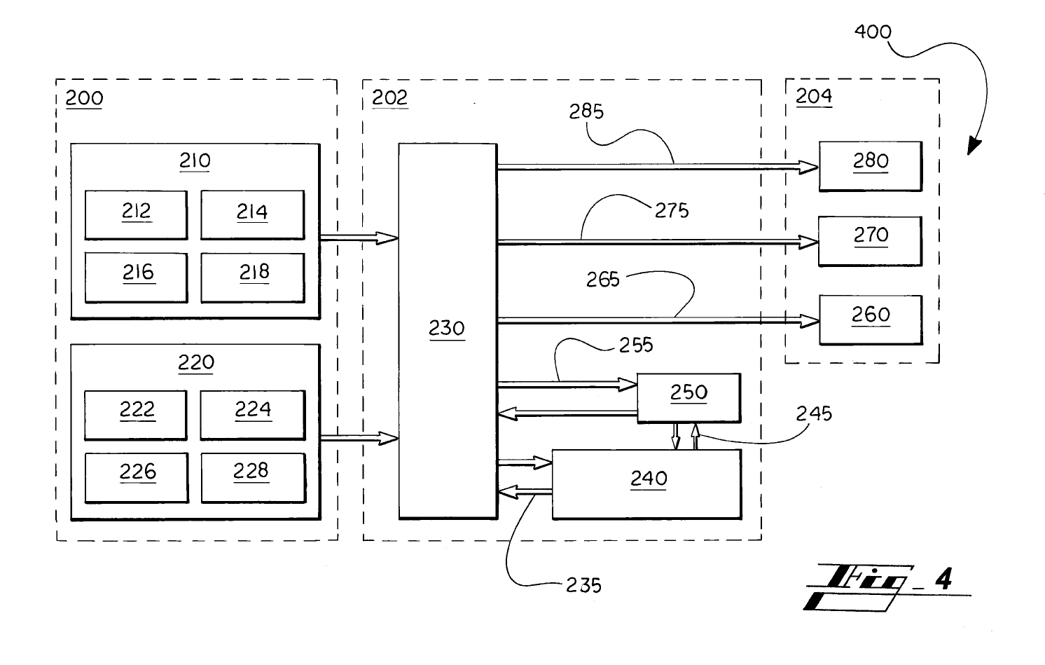

### V. Algorithms and Processes—FIG. 4

FIG. 4 shows an example algorithm, represented schematically by a process flow 400, according to embodiments of the present technology. Though a single process flow is shown for simplicity, any of the functions or operations can be performed by one or more devices or systems, in one or more or processes, routines, or sub-routines of one or more algorithms.

It should be understood that the steps, operations, or functions of the process flow 400 are not necessarily presented in any particular order and that performance of some or all the operations in an alternative order is possible and is contemplated. The processes can also be combined or overlap, such as one or more operations of one of the processes being performed in the other process.

The operations have been presented in the demonstrated order for ease of description and illustration. Operations can be added, omitted and/or performed simultaneously without departing from the scope of the appended claims. It should also be understood that the illustrated process 400 can be ended at any time.

In certain embodiments, some or all operations of the process 400 and/or substantially equivalent operations are performed by a computer processor, such as the hardware-based processing unit 106, executing computer-executable instructions stored on a computer-readable medium, such as the data storage devices 104 of the system 20, described above.

### V.A. Input Group 200 of the Algorithms

The input group 200 include various input modules 210, 220.

### V.A.i. Alert-Condition Input Module 210

The alert-condition input module 210 comprises code configured to cause the hardware-based processing unit 106 to receive and/or determine input indicative of a present alert condition. The alert condition is one of multiple alert conditions that the module 210 is pre-configured to recognize.

As shown in FIG. 4, the deliberation group 202 receives, as input, output from the input group 200 and, particularly here, from the alert-condition module 210.

The pre-established alert conditions can include any condition that the vehicle 10 (or other subject apparatus, or machine) is programmed to alert a user about. The condition can be referred to as a trigger, or trigger condition, and the condition occurring or being present can be referred to as the condition being satisfied or triggered.

Alert conditions are circumstances that the vehicle is pre-programmed to recognize as a trigger to provide an alert, or alert notification, to the user or users of the vehicle. Users can include the vehicle driver and one or more passengers.

The alert condition in some implementations includes, in addition to a primary circumstance, details of the circumstance. for instance, regarding a vehicle backup sensor, example alert conditions can include:
1. vehicle in reverse, headed toward an aft-ward object (primary alert condition) and within 15 feet (details of the alert condition) of the object,
2. vehicle in reverse and vehicle within 10 feet of the object, and
3. vehicle in reverse and within 5 feet of the object.

Of note, the distance from the object, relating directly or intimately with the alert condition, is part of the respective alert conditions, not part of the contexts, or contextual inputs (reference, module 220), of the present technology.

Example alert conditions also include, but are not limited to, a seatbelt alert condition, various types of proximity alert conditions, and a vehicle-status alert condition. Each is associated with at least one vehicle sensor (for example, sensor sub-system 60, FIG. 1) or other input that can indicate if or whether the alert condition is present. The other input can include, for instance, a weather forecast or communication from a nearby vehicle (v2v), as just a few examples.

Other example alert conditions also include, open door, open trunk, open fuel door, and others mentioned below.

One or more system modules or sub-modules can be dedicated to one or more underlying alert conditions. As examples, FIG. 4 shows a seatbelt alert sub-module 212, a proximities alert sub-module 214, and a vehicle-condition sub-module 216.

Regarding the seatbelt alert sub-module 212, the seatbelt alert can be associated with a seatbelt sensor (of the sub-system 60) configured to indicate when a seatbelt is not connected. Typically, vehicles are configured so that an alert condition is determined if the seatbelt is disconnected and the vehicle 10 is being driven.

Regarding the proximity alert sub-module 214, most modern vehicles have sensors for proximity detection and are programmed to recognize one or more proximity alert conditions. The vehicle 10 can include a backup sensor sensing distance between the sensor and an object behind the vehicle 10, and a proximity alert can be triggered when the vehicle 10 is within a pre-determined distance from the object.

The vehicle 10 can include one or multiple sensors for determining when the vehicle 10 is too close to objects in other directions as well, including sides, front, or corners, such as blind-spot areas. These can be useful when entering or exiting a tight parking spot in a garage, for instance.

Another example proximity-related alert condition relates to following distance, or an amount of separation between the subject vehicle 10 and a forward vehicle. The subject vehicle 10 can include a sensor sensing the separation distance, and be configured to determine that a forward-proximity alert condition is triggered if the separation distance is too small.

Further regarding the vehicle-condition sub-module 216, the vehicle 10 can be programmed to alert a user of any of a wide variety of conditions, including vehicle-specific conditions. Examples include, but are not limited to, a low-tire-pressure alert condition, a door-ajar alert condition, an excess-speed alert condition, a fuel-low alert condition, engine-heat alert condition, oil-level alert condition, door-ajar alert condition, trunk-open alert condition, and a vehicle-location alert condition.

Vehicle-location alert conditions can be based on GPS or other positioning data, for instance, and be triggered if the vehicle 10 has deviated from a pre-determined desired position or direction, or needs to change or maintain direction to stay on a desired route.

As mentioned, reference 218 in FIGS. 3 and 4 indicate expressly that the alert-condition module 210 can include other sub-modules.

### V.A.ii. Contextual-Input Module 220

The contextual-input module 220 of the input group 200 comprises code configured to cause the hardware-based processing unit 106 to receive and/or determine input indicative of a context relevant to determinations of the deliberations group 202. As shown in FIG. 4, output of the contextual-input module 220 is input to the deliberation module 230.

Generally, context sub-modules 222, 224, 226, 228, etc., relate to any determinable condition or situation calling for a heightened level of importance and/or reducing a likelihood that an alert notification from the vehicle 10 would be appreciated or received by the user.

Context does not relate directly to the underlying alert condition. For instance, as provided, for an alert condition of a vehicle 10 backing up toward an object, the fact that the vehicle is within 10 feet of the object is a part of the alert condition, not context. A window being open, a loud external noise, and a baby crying loudly are example contexts.

In response to the alert condition (for example, vehicle approaching and within 10 feet of an aft-ward object) being determined and processed by the alert-condition module 210, the contextual-input module 220 determines whether there is any relevant context, such as the baby crying, calling for a heightened level of importance and/or that may reduce a likelihood that the alert notification from the vehicle 10 would be received or appreciated by the user.

Example contexts include, but are far from limited to, ambient noise level and/or type, driver attention, or level or focus (for example, direction) of perception or distraction, road conditions or other environmental or ambient conditions, location (for example, GPS coordinates), driver or passenger age, and a driver or passenger condition.

Regarding driver perception, for instance, the context can indicate that though a ball or other object is moving into a vehicle path from the right, the user's head and/or eyes appear, based on vehicle camera or other sensor data, to be focused toward the left, and so not noticing the ball. The context can also or instead include user actions, or lack of action. In the ball example, the context can include the user not applying the brakes and/or not moving the steering wheel as the system is programmed to recognize as prudent or appropriate under the circumstances.

Further regarding driver context, the system can be programmed to determine a user workload. The variable can be referred to by other terms, such as driver workload factor, user-attentiveness, user-attentiveness factor, user-bandwidth, or user-bandwidth factor. The factor could be higher when there is a baby crying and it is raining heavily, for instance, than if these conditions were not present. The deliberation module 230 can be programmed to consider the user workload factor in determining the alert notification to provide.

One or more of modules or sub-modules can be dedicated to one or more relevant contexts. As mentioned, FIGS. 3 and 4 show multiple context sub-modules:
a person-related context sub-module 222,
   Relating to relevant user characteristics, such as driver and/or passenger(s) qualities or actions (e.g., perception or lack thereof); as just a few examples;
a vehicle-related context sub-module 224,
   Relating to severity of a flat tire; vehicle occupancy (could also or instead be under 222); vehicle activity (such as vehicle speed); vehicle or driving mode (such as transmission position—park/reverse/drive); or vehicle conditions (such as fuel level); as just a few examples; and
an environment-related context sub-module 226,
   Relating to weather; time of day; road conditions; or user or group or team (e.g., construction site team) calendar, plan, itinerary or other pre-set reminders or timing and activity outline; location, relevant for instance to a flat tire situation
      proximity to a service station, highway exit, or home;
location, relevant to proximity to a current or planned (routed) travel direction; as just a few examples.

Further regarding the person-related context sub-module 222, and driver attention or perception examples, one or more sensors, such as cameras and/or biomedical sensors, can be configured and arranged at the vehicle 10 to sense driver characteristics indicative of driver state, such as regarding: (1) level of driver attention or perception; (2) level of drowsiness or apparent temporary incapacity (for example, apparent drunkenness); and (3) direction or area of driver attention or perception direction—for example, if the driver is looking toward a rear passenger area, or whether the driver has noticed a ball entering the street from the right.

Further regarding the person-related context sub-module 222, and driver or passenger condition examples, one or more sensors, such as cameras and/or biomedical sensors, can be configured and arranged at the vehicle 10 to sense a driver or passenger condition, such as an apparent hearing or eye-sight condition, that may affect how or whether an alert or notification from the vehicle is processed by the person.

Or the system can determine, generate, or receive contextual input indicating that the user has a relevant condition, such as an apparent or known impairment. Such contextual input can be received from a vehicle sensor, a database of the vehicle 10, a database of a local device (for example, local smartphone), or a remote database, such as a remote customer center such as an OnStar® center. The database comprises data corresponding to the user. The user data can be part of a profile or user account at the database, and indicate relevant user characteristics, which may be provided by the user or other authority—parent, employer, doctor, or municipality or government agency, such as the department of motor vehicle.

In one embodiment, the system generates, determines, or receives contextual input indicating an age of the user—drive or passenger. While age does not have a complete correlation to diminished ability to process notifications, such as a chime produced at the vehicle 10, the algorithm can be programmed to consider age of the user, alone or with one or more other contextual inputs, in determining a type of notification to improve the likelihood that the user will receive the notification. Some studies have shown, for instance, that many elderly people have lower sensitivity/more difficultly hearing higher-frequency sounds. As described more below, an output for an elderly driver may be designed to include a louder sound, provided at a lower frequency, and/or other sound features.

Generally, configuration of the customized notification to correspond with the circumstance (alert condition and context), whether made dynamically at the vehicle 10, or in advance, and whether made by modifying a base or standard file, are those determined best, or preferred according to a cost-benefit analysis, to catch the attention of the user, communicate the notification message to the user, and/or communicate an urgency of the message. Further regarding the elderly driver example, the customized notification can be configured with select characteristics, in addition to volume and frequency, as mentioned, such as starting time of direction (e.g., earlier to give more reaction time), duration of notification (e.g., longer to give more time for user processing/appreciation), and cadence (for instance, decreased cadence, also to give more time for user processing/appreciation)

In contemplated embodiments, the system is programmed to associate one or more conditions with one or more corresponding likely related contexts. In an example, if vehicle location data (such as GPS data) indicates that the user is on a dirt road, the road will cause environmental noise when driven over, especially at relatively higher speeds. The system can be programmed to associate a dirt road condition with an environmental noise context, whether a vehicle 10 sensor is used to actually sense the noise. The deliberation module 230 could, in response to the dirt road condition, then, select a sound configured to overcome or counter the (presumed) noise, such as by being louder than a base sound, and/or having other characteristics configured to counter the noise, such as frequency or tempo.

The system can be programmed with one or more thresholds, or threshold values, relating to any of the various context, such as threshold speeds, which trigger different corresponding levels or types of alert notification. Other example thresholds include how far from a preferred location of area a driver is focusing on. If the driver is looking forward or slightly left of front, an alert notification can be gentler with respect to a slow-moving right-of-front entering hazard, than if the driver was looking farther to the left or the object is moving faster. The threshold can be represented in this case by an angle, for example, or a distance between the target and actual lines of sight measured at plane, such as at a vehicle windshield.

Input noise can be characterized by various qualities, such as spectral content (e.g., frequency, amplitudes, phase) and sound envelope. A noise can be represented at the system by a noise ID. Noise characteristics, or ID, can include or be associated with, in addition to conventional noise features (frequency, pitch, tone, volume, etc.), a directional or localization feature indicating a direction from which the noise is approaching the user from—for instance, from beyond a forward-left side of the vehicle 10 versus from beyond a right-rear.

Customized notification sound can likewise be characterized by various qualities, such as spectral content (e.g., frequency, amplitudes, phase) and sound envelope. A sound can be represented at the system by a noise ID, or sound file or file name. Sound characteristics, ID, or file can include or be associated with, in addition to conventional noise features (frequency, pitch, tone, volume, etc.), a directional or localization feature indicating a direction from which the noise should be provided to, or a direction along which the noise should be provided, to best be received and appreciated by the user—for instance, toward a driver left ear versus right ear, because the context indicates distracting noise at the right ear, and so the left ear is more available to receive the notification; or more toward a driver left ear, because the context indicates distracting noise at the left ear, and the extra sound toward the left ear helps overcome the distracting noise on the left side.

The notification sound characteristics, ID, or file can also include a timing by which to provide the sound, such as sooner for older drivers, or apparently drowsy drivers, to give them more time to react accordingly.

In another example, if the user is apparently not facing forward, the determined notification output includes a steering-wheel vibration, promoting forward user attention.

Example haptic output includes but is not limited to providing vibrations, by way of an actuator, such as by way of a steering wheel, brake or gas pedal, foot-well floor, seat-belt assembly (strap or other portion of the assembly), or a bottom, left/right cushion, and/or back of a driver seat, for instance. A seat back vibration could be used to promote rear-ward user attention, such as regarding an object behind the vehicle, for example. These areas may trigger localized haptics, which in various embodiments and circumstances can be coupled with a sound, such as a directional sound—such as a sound focused toward the driver from the right, with a right seat back vibration and/or right side of steering wheel (based on whatever position it is in at the time), to indicate a right-side-of-vehicle hazard.

Considering that the steering-wheel angle changes constantly, to my mind, in some embodiments the steering wheel is used to provide forward-focused warning, such as by a full steering wheel vibrate or balance left/right vibration (in either case, this can be referred to as a central, or central/forward, haptics for the steering wheel) warning of a hazard in the vehicle forward path. Sound in this case can be provided from the front toward the driver, or in more of a diffused or balance manner, which will not tend to draw user attention left or right unnecessarily.

One or more balanced or central haptics (steering wheel, center of seat back, etc.) and/or sounds can be used also for notifications that are not related to the vehicle center (fore or aft in the vehicle path), such as regarding a seatbelt unbuckled while the vehicle is travelling at a high speed. The central or balanced haptics and/or sounds should, again, not tend to draw user attention left or right unnecessarily.

In various embodiments, visual notifications are provided in a left/right, balance, or central manner, as referenced in the preceding paragraphs regarding sound and haptics. The visual indications, such as a warning provided at the center or right side of the windshield, could be provided in conjunction with corresponding sound and/or haptics.

In various embodiments, delivery of notifications is presented in a pre-established sequence, such as from appropriate haptics (localized or non-localized, directional (fore (e.g., steering wheel, pedals), aft (e.g., seat back), left, right, etc.) or non-directional/balanced/central) to same combined with visual, then sound as the urgency increases. The system can be programmed to determine an increased urgency level in various ways, such as by speed increasing while a seatbelt is unbuckled, or generally by the driver not responding as suggested by the earlier—e.g., haptic only—notification. The order, timing, combinations (e.g., distinct haptic/sound/visual or some of these overlapping at stages of the sequence), and types (e.g., sound, visual, haptic characteristics) of warning for such sequences can be configured as desired.

Example visual outputs include but is not limited to visual indications delivered by way of a vehicle dashboard display, a vehicle central-stack display, and a vehicle heads-up display (HUD).

Further regarding the vehicle-related context sub-module 224, the vehicle 10 can be configured with one or more sensors configured and arranged to determine any vehicle-related condition that may indicate a context calling for a heightened level of importance and/or a context that may reduce the likelihood of an alert being appreciated or received by the user. As an example, a vehicle context can include a heating, ventilation, and air-conditioning (HVAC) fan being on high, and so relatively loud, which may affect a user's ability to hear an alert chime. Noise from a vehicle audio system (for example, radio) can also be a relevant vehicle context, and can in some embodiments be determined by the vehicle without a sound sensor (for example, microphone), such as in response to the audio system being turned on or to a known volume level that the audio system is set to.

In a contemplated embodiment, vehicle audio-system noise is sensed by a sensor, and considered as an ambient or environmental context, processed by the environmental sub-module 226. Any vehicle-generated noise can be measured along with any other sound, such as sounds of a passing fire truck, a construction site, or heavy rain. A rain context can be determined based on any of various inputs, such as noise sensed by vehicle microphone, vehicle wipers being on, a windshield sensor, a wet road being sensed by another vehicle sensor, etc.

In various embodiments, context can include pre-established information that is not associated with sensor data. For instance, if the system is used on a crane or other machine used by a person, such as at a construction site, the system could be programmed to recognize as context, information from a schedule, agenda, or other plan indicating that a loud machine is being or will soon be operated nearby. The context can be processed by the deliberation module 230 in the same manner that the module would process contextual data reflecting the vehicle sensing of the loud nearby machine.

In a contemplated embodiment, context data is received from another system, adjacent or near the vehicle 10, such as context data received by the vehicle 10 from a nearby vehicle (v2v), an electronic user communication device, highway infrastructure (v2i), or other system (v2x). For instance, another vehicle may sense that a noisy emergency vehicle is moving toward the subject vehicle 10, before the subject vehicle 10 senses the same, and the subject vehicle 10 can receive and act on a related message from the other vehicle.

Context data can include general environmental or situational conditions, such as time of day, time of year, weather, or environment, such as whether the system is being used at sea versus in a quieter and/or stiller environment.

Further regarding schedule or plan data, context data can include characteristics of one or more present or planned tasks, such as stops for a bus, a next tourist attraction being approached on a tour being provided using a vehicle equipped with the present technology, or collaborative mission functions of moving machines working together—e.g., trucks, cranes, emergency/first-responder vehicles, military vehicles.

In a contemplated embodiment, for the tour example, context including vehicle location can not only affect what information is provided to the tourists, and when, but also types and modes of the notification, such as via right bus speakers along with right-side of vehicle (e.g., right-side bus windows) augmented reality display for the tourists regarding a right-side attraction.

Further regarding, the environment-related context sub-module 226, the vehicle 10 can be configured with one or more sensors configured and arranged to determine any environmental condition that may indicate a context calling for a heightened level of importance and/or a context that may reduce the likelihood of a notification being appreciated or received by the user if the notification is not customized according to the present technology.

In various embodiments, the vehicle 10 can be configured to determine characteristics beyond just volume level of an environmental noise, whether vehicle-created noise or other. As just a few examples, frequency, pitch, tone, cadence, rhythm, or other context noise characteristic(s) can be determined.

Sounds can be monophonic or polyphonic, or both at different times of presentation—e.g., start with monophonic and transition to polyphonic, or vice versa, or alternate. Example modifications that can be made to sounds, such as polyphonic sounds, in various embodiments include any known type of adjustment, such as distortion, which can be linear or non-linear, and include clipping—soft clipping or hard clipping, for instance. A polyphonic sound can be made harsher, for example, by hard clipping.

In various embodiments, to make sounds seem more urgent to the user, sound characteristic variations can include flattening of the sound. The flattening can focus, for instance, on a prominent frequency or frequencies, such as that associated with a shorter and/or louder sound or a shorter and/or louder portion of sound. As another example variation, the sound could be distorted to give the user a perception of something harmful to get their attention—e.g., a siren sound, a stick breaking, etc.

The vehicle 10 is in various embodiments configured to generate a customized notification configured best, or preferred according to a cost-benefit analysis, to communicate the alert condition to the user under the circumstances including by the alert condition and context. A multi-mode notification may be preferred, for instance. Or notification sound features may be selected to counter, overcome, or otherwise be detected over a contextual noise.

### V.B. Deliberative Group 202 of the Algorithms

The deliberative group 202 includes multiple modules 230, 240, 250 for determining a customized alert notification, concerning an alert condition determined present or triggered by the alert-condition module 210, and customized based on relevant contextual input received from the contextual module 220.

### V.B.i. Deliberation Module 230

The deliberation module 230 is a primary module of the deliberative group 202 in various implementations of the technology. The module 230 can be referred by any of multiple other descriptive terms, such as contextual-output-manager, a deliberative agent, or an intelligent agent.

The deliberation module 230 determines a customized alert notification to be delivered via the output group 204. The notification can include one or more distinct notifications, provided by one or more modes of communication. The notification can include a customized audible alert delivered via a vehicle speaker system and a customized visible alert delivered via a vehicle display, for instance.

The deliberation module 230 determines the customized alert notification based on input data received from the input group 200. As provided, the inputs include input alert data from the alert-condition input module 210 and input context data from the contextual-input module 220.

The input alert data indicates the existing type of alert condition, such as a disconnected seatbelt, backup proximity, a forward separation (following too close), an object entering the road, etc.

The context data can include one or more relevant contexts—for example, contextual facts—indicating how the alert notification should be customized, or which pre-customized notification should be selected, to increase the likelihood that the notification will be sensed and appreciated by the user.

Regarding the mentioned ‘heightened level of importance,’ the context can indicate to deliberation module 230 that the notification output should be customized, or different than a base or standard notification that the vehicle 10 would normally provide in response to the alert condition.

For example, the deliberation module 230 may determine based on the context that the situation calls for a heightened level of importance. The deliberation module 230 can be programmed to affect notification, and/or vehicle system adjustments (e.g., window, HVAC) in any of a wide variety of ways without departing from the scope of the present disclosure. The deliberation module 230 may determine that providing the notification by multiple modalities (multi-mode) is best, or preferred according to a cost-benefit analysis, under the circumstances to increase the likelihood of a message or target goal of the notification is appreciated by the user. Multi-mode notifications can be provided by two or three of audio (e.g., chime), visual, and haptic modes. And/or the deliberation module 230 can determined that a base notification should be modified (e.g., enhanced) to increase the likelihood of being sensed by the user and/or also to communicate urgency.

No matter, why or how modified, a modified notification can be referred to as a derivative of the type of notification that would have been provided without the modification, referred to above as the base or standard notification.

Example context triggering a heightened level of importance include, for instance, a speed of the vehicle. If a user has not fastened his seatbelt (alert condition), for instance, the importance level of the need for them to fasten the seatbelt increases as vehicle speed increases, because statistically the risks, or situation, of an accident and injury increase with speed. The ‘risk’ can include situations not commonly seen ask a “risk,” such as the risk of making a wrong turn in following a route.

As another example or risk analysis, the vehicle 10 is, in a contemplated embodiment, programmed to differentiate, as best able, between an animate and inanimate external object. The contextual-input module 220 can determine based on sensor data (for example, camera, sonar, laser, radar) that the object appears to be animate, such as a person walking in front or behind the vehicle 10, as opposed to a pole or ball rolling. The system can be programmed to determine that the risk of the potential incident is higher when the object is animate. In this case, for instance, a system designer could have determined that although damage to the vehicle would likely be higher if the object is a static object such as a fire hydrant, personal injury is more important, and so programmed such risk analysis into the algorithm.

As another example or risk analysis, the vehicle can be programmed to determine a higher risk, and correspondingly more aggressive or calculated (calculated to be sensed by the user) alert notification, when a vehicle opening is open, such as when a trunk is open or a driver or passenger door, and either or both: a speed threshold/s is/are exceeded and/or a time threshold/s (e.g., for how much time the opening is open) is/are exceeded.

As another example or risk analysis, the vehicle can be programmed to determine a higher risk when a child seatbelt is undone, versus an adult. Whether the person is a child can be extrapolated based on weight of the person sensed by an in-vehicle-seat sensor, or height determined based on camera data, for instance.

### V.B.i.a. Deliberation Module—Constituent Agents

In various embodiments, the deliberation module 230 can include multiple agents, functional portions, or functions, such as a rule-based agent, a deterministic agent, a deliberative agent, and a learning agent.

Generally, a rule-based agent determines an appropriate result in a relatively simple manner, based on one or more inputs and one or more pre-set rules. Processing, e.g., deliberating, of the rule-based agent toward the result is relatively light. If a rule requires that an alert notification level for seatbelt unbuckled be increase with speed, the deliberation module needs to know that the seatbelt is unbuckled (alert condition) is present and the vehicle speed (context) to determine the appropriate output (using the pre-set rule).

The deterministic-agent functions require more processing, relative to the rule-based agent functions, evaluating more or more-complex data. In various embodiments the deterministic agent computes a level of urgency corresponding to a current situation based on one or more of driver, car and environment contexts, and corresponding models. As an example, if a ball is rolling into a path of the vehicle 10, the deterministic agent of the deliberation module 230 may (1) evaluate whether the driver apparently sees the ball, as can be extrapolated from whether the user's head and/or eyes are directed toward the ball during a relevant time window and/or whether the user applies the brakes if slowing the vehicle would be prudent, and (2) determine, based on a pre-established model, appropriate notification modes and types. As another example, the system can determine that the user is looking at a certain area of the car, such as at the center console, and so provide a visual component of an alert notification via a central-stack screen, instead of via an instrument panel, for instance, so that the driver knows more quickly that they need to take an action, such as to look up and slow down.

The deliberative agent in various embodiments performs cost-benefit analysis. The agent can consider a relationship between (I) the cost of providing a certain level or type of notification (e.g., processing resources, driver distraction, user enjoyment of the vehicle-use experience, and safety) and (II) the benefit of providing the notification, such as a benefit of avoiding risk. The system can be programmed to recognize that relatively high costs of providing an aggressive multi-modal notification (e.g., (a) relatively high volume and pitch chime at high tempo, with (b) high intensity vibration at high tempo, and (c) bright visual) are outweighed in some circumstances. Such costs are easily outweighed, for instance, by the benefits associated with avoiding the risk of injuring a person. The deliberative agent in various implementations, chooses the alert notification, or characteristic of the notification, based on the cost-benefit analysis, toward the goal of reducing harm, maximizing reaction time, etc. The agent can be programmed to reason, and make decisions based on artificial intelligence.

The learning agent is configured in various embodiments to determine the alert notification or characteristics for the notification (the file choice or the parameters of a sound or other-mode communication to be provided), or data to be used in present and/or future determinations of alert notification or characteristics for the notification, based on information obtained in system operation. The information can indicate user reactions to prior notifications, for instance. For example, the system ca be programmed to, if the driver did not react to a certain type of alert notification (e.g., type of custom sound of a customized sound file) under a circumstance, use a different alert notification, changed in one or more ways from the prior notification (having been missed, ignored, or causing slower reaction than desired) when the same or similar circumstance arises again, to increase the likelihood of the desired result, such as user response in a desired manner and timing. If an alert notification is provided while it is raining, for instance, and the driver does not response, or responds slowly, the leaning agent can adjust the system accordingly. The next time a similar situation arises, the system can, based on the learning and corresponding stored association between the prior relationship (alert condition, context, notification, and result), or based on a new relationship created by the learning agent (same alert condition, same context, adjusted notification (such as a louder notification)), provide the adjusted notification. The process can be repeated in connection with the same input, and in other situations, thereby personalizing the system to the user(s)—user sensitivities, abilities, proclivities, reaction time, attention tendencies, and preferences, communicated expressly to or, or inferred by, the learning agent, for instance. As another example, if, when a visual component of an alert notification is presented by a screen in the vehicle central stack, the driver takes longer to react, then the next time, under similar conditions, the system may, based on its programming and operation of the learning agent, present the visual in a different location of the vehicle and/or present notification by another mode, such as sound or vibration. And the learning agent may be programmed to determine that the user responds better to certain combinations of notification, such as by responding better when a visual component of the notification is provided by a heads-up display, accompanied by a gentle chime, than if the visual component is delivered by a central-stack screen, even if the chime is louder.

The modules, sub-modules, examples and other descriptions herein relating to the present system, including the deliberation module 230, can be considered performed by, or influenced by (e.g., database data affected by results from the learning module) one or more of these agents. Various agent operations can overlap in various embodiments, such as by the rule-based agent determining that an alert level should be increased due to a high vehicle-speed context, the learning agent advising that, based on past, like, circumstances, the user appears to respond more to HUD input combined with high tempo sound, and the deliberative agent determining under all of the circumstances, which can include context not considered by the rule-based agent, to provide the resulting notification.

### V.B.i.b. Deliberation Module—Sound-Related Functions

While generation of a customized sound file is described heavily herein, the deliberation module 230 can be configured, as mentioned, to determine one or more other types of customized notification output, such as customized visual output and customized haptic output. The primary sound-related embodiments are described by way of example, next.

While the sound data determined by the deliberation module 230 can take any of a wide variety of forms and be referred to in many ways, such as sound packet, sound message, sound-indicating instruction, an acoustic or audio packet, etc., the result can be referred to for simplicity as a sound file. The sound file can have any of a variety of types, such as way, aiff, au, raw, flac, mpeg-x, etc.

To determine or obtain a customized sound alert notification, the deliberation module 230, in various embodiments, accesses a database or database module 240 to obtain a customized sound or sound file appropriate to the circumstances. The access is indicated schematically by reference numeral 235.

The deliberation module 230 uses the input alert condition and the contextual input data in obtaining the customized sound file.

In a contemplated embodiment, the deliberation module 230 determines a situational profile, or indicator representative of the circumstances, based on the input alert data and the contextual input data, and accesses the database module 240 to obtain the customized sound or sound file corresponding to the situational profile or indicator.

The profile or indicator can include, for instance, data indicating the type of alert and data indicating the context, such as data indicating qualities of, or just presence of, a loud ambient or environmental sound, such as of a construction site that the vehicle 10 is passing. Noise qualities can include volume, direction, rhythm, frequency, tempo, tone, and/or other acoustic characteristics, as just a few examples.

The database module 240 in various embodiments includes one or more data structures configured to facilitate the deliberation module 230 determining the appropriate customized sound. As an example, the database can include a look-up table, or other array, matrix, other indexing arrangement, or other relational data structure or arrangement, relating various sets of conditions—such as a condition set including an alert condition and one or more contexts—to a corresponding recommended customized sound file particular to the circumstances. The indexing arrangement can be the models referenced above in connection with the deliberative agent of the deliberation module 230.

Some or all of the relationships, pre-programmed into the database and/or system code regarding input alert conditions and contact and resulting notifications to be provided, are pre-determined by system designers, such as engineers and behavioral scientists based on testing separate form on-road use and/or on feedback from actual use.

As an example, if an ambient or environmental noise has a certain pitch or sound signature (for example, x pitch (based on y frequency), z volume), then the associated customized sound determined can include a sound having a signature that acts to cover, counter, cancel out, or otherwise accommodate the environmental sound so that the determined sound is more likely to be heard by the user over, or despite, the environmental noise.

In various embodiments, the system determines one or more notification sound characteristics in a manner to maintain a pre-set relationship between customized-sound and input-noise characteristics. The relationship can be a ratio, for example. The system could be programmed to control volume of the notification sound such that it bears a pre-determined relationship to the ambient noise. The ratio could require that the notification sound be 1.5 times as loud as the ambient noise (or a 1.5:1 notification-sound/ambient-noise ratio), for example.

Other example use cases are provided below.

In various embodiments, the deliberation module 230, alone or using a notification-generation module 250, generates the customized sound file. In some implementations, the deliberation module 230, as part of generating the customized sound file, consults the database module 240. The access is indicated schematically by reference numeral 255.

The generation module 250 could be configured to consult (path 255) the database module 240 to obtain a base or standard sound file, such as a sound file that would be used in a conventional system, or that would be used if there was no context data, in connection with the subject alert condition received from the alert-condition input module 210. The generation module 250 is in this case configured to then modify (or adjust or reconfigure) the base sound file, associated with the alert condition, based on the context received from the contextual-input module 220, yielding the customized sound file.

In various embodiments, the generation module 250 could be configured to consult (path 255) the database module 240 to obtain modification data, or reconfiguration data, indicating a manner that a base sound file should be adjusted to form the customized sound file. The generation module 250 could also, in this case, obtain (path 255) the base sound file from the database module 240 or from another repository. The generation module 250 then generates the modified file—e.g., reconfigures the base file—accordingly, yielding the customized sound file.

The deliberation module 230 is in some implementations configured to generate the customized sound file without using a base sound file. The deliberation module 230 could still be configured in these implementations to consult (path 255) the database module 240, such as to obtain one or more components, not separately amounting to a base sound file, to be used in forming the customized sound file.

### V.B.i.c. Deliberation Module—Other Functionalities

As mentioned, in various embodiments, while the deliberation module 230 is a contextual-sound manager, or sound-agent manager, dedicated to determining customized sound files, the system can include one or more other modules configured to determine one or more other types of customized alerts. The one or more additional modules can be considered symbolized in the figures by place-holder module shown at numeral 295 in FIG. 3, for example. The other module(s) could be associated with visual and/or haptic output, for instance, and so referred to as a contextual-visual manager or contextual-haptic manager, respectively.

For simplicity, the module(s) performing these other deliberations are referred to below still as the deliberation module 230, though they may include a contextual-visual manager, a contextual-haptic manager, and/or other.

Visual notification variables include, but are not limited to, display location, color, brightness, and start timing, or time at which provision of the output is commenced.

Haptic notification variables include, but are not limited to, vibration location, vibration velocity, vibration acceleration, vibration frequency, vibration amplitude, and start timing.

Regarding vibration location, the location determined can relate to the subject context, such as being at a steering wheel in connection with a hazard in front of the vehicle 10, or being at a seat back in connection with a hazard behind the vehicle 10; and in contemplated embodiments, appropriately weighted partially or fully toward the right or left in each case as the circumstance may warrant, such as a right rear seat vibration if the hazard is in a right-side blind spot.

As with the contextual-sound manager portion of the deliberation module 230, the other deliberation-module functionality is based on data from the input group 200. The input includes alert data from the alert-condition input module 210 and context data from the contextual-input module 220. The input alert data indicates the existing type of alert condition, such as a disconnected seatbelt, backup proximity, a forward separation (following too close), object entering road, etc. The context data indicates one or more relevant contexts—for example, contextual facts—that can indicate how the extra-sound alert notification (for example, visual and/or sound) should be customized to increase the likelihood that the notification will very likely, or most likely, be sensed by the user.

To determine or obtain one or more other customized alert notifications, beyond sound notifications, the deliberation module 230 in various embodiments, accesses the database or database module 240 or another database, to obtain at least one customized non-sound packet, message, file, or instruction—for example, a visual instruction (or, visual-display instruction) or haptic instruction (or, haptic-output instruction)—appropriate to the circumstances. The access is indicated schematically by reference numeral 235. The non-sound data, regardless of form (file, packet, etc.), is referred to primarily herein as an obtained ‘instruction,’ for simplicity and to distinguish the sound ‘file’ obtained.

In a contemplated embodiment, the deliberation module 230 determines a situational profile, or indicator representative of the circumstances, based on the input alert data and the contextual input data, and accesses the database module 240 to obtain the customized sound or sound file corresponding to the situational profile or indicator. The situational profile can be the same as that used to obtain the customized sound file, described above. The profile or indicator can include, for instance, data indicating the type of alert condition and data indicating the context, such as data representing qualities of a loud ambient or environmental sound, such as from a construction site that the vehicle 10 is passing—for example, volume, direction, pitch or frequency, tone, and/or other acoustic characteristics.

The database module 240 in various embodiments includes one or more data structures configured to facilitate the deliberation module 230 determining the appropriate customized output—visual and/or haptic, for instance. As an example, the database 240 can include a look-up table, or other array, matrix, or other indexing arrangement, relating various condition sets—such as a condition set including an alert condition and one or more contexts—to a corresponding recommended visual-display instruction and/or vibration instruction, customized to the circumstances.

In various embodiments, the deliberation module 230, whether using the generation module 250, generates the customized instruction(s). In some implementations, the deliberation module 230, as part of generating the customized instruction(s), consults the database module 240. This access can also be considered indicated schematically by reference numeral 255.

The deliberation module 230 could be configured to consult (path 255) the database module 240 to obtain a base instruction(s) (for example, a base visual-output instruction or base vibration-output instruction), such as a base instruction that would be used in a conventional system, or that would be used if there was no context data, in connection with the subject alert condition received from the alert-condition input module 210. The deliberation module 230 is in this case configured to then adjust or reconfigure the base instruction(s), associated with the alert condition, based on the context received from the contextual-input module 220, yielding the customized instruction(s).

In another case, the generation module 250 could be configured to consult (path 255) the database module 240 to obtain reconfiguration data, indicating a manner that a base instruction should be adjusted to form the customized instruction. The deliberation module 230, in various embodiments of this case, also obtains (path 255) the base instruction from the database module 240 or from another repository. The generation module 250 then reconfigures or otherwise modifies the base instruction accordingly, yielding the customized instruction.

The generation module 250 is in some implementations configured to generate the customized instruction without using a base instruction. The deliberation module 230 could still be configured in these implementations to consult (path 255) the database module 240, such as to obtain one or more components, not separately amounting to a base instruction (for example, a base haptic instruction or base visual instruction), to be used in forming the customized notification instruction.

Visual notification characteristics determined can include display location and type of visual notification provided. Locations can include a vehicle center-stack screen, instrument panel area, or heads-up display. Characteristics can also include brightness(es), size(s), shape(s), lettering, numbering, and color(s).

Visual notification characteristics can also include position within a display device or medium. If a ball is rolling into a vehicle path from the right, for instance, the system can be programmed to, based on context indicating that the user apparently does not see the ball, highlight the ball, such as by dynamic outline on a heads-up display (HUD) or other medium at the windshield or between the user eyes and the ball (e.g., holographic display). Or the visual notification can include an arrow pointing in a direction of the ball.

### V.B.i.d. Deliberation Module—Coordinated Notifications

The deliberation module 230 (and/or the generation module 250) is in contemplated embodiments configured to, in generating the customized sound file and at least one other notification instruction, process system code causing the processing unit 106 to determine a preferred relationship between output of the customized sound and the other notification communication.

The system could be configured so that chimes of a customized sound are provided at a first tempo or frequency by which each chime is delivered between corresponding vibration output delivered according to a second tempo or frequency, whether the haptic output results from base visual instruction or a customized haptic instruction.

As another example, the system could be configured so that chimes of a customized sound are provided at a tempo or frequency so that each chime is delivered at the same tempo or frequency by which visual output is provided to the user, whether the visual output results from base visual instruction or a customized visual instruction.

### V.B.i.e. Deliberation Module—Vehicle-Systems

In various embodiments, the deliberation module 230, the notification-generation module 250, or another module (which can be represented generally by numeral 295 in FIG. 3) determines adjustments that can be made to one or more apparatus systems or structures—e.g., vehicle systems. While the apparatus can be other than a vehicle, such as an aircraft or place of habitation, the apparatus system is described primarily herein as a vehicle system by way of example and not limitation.

In some cases, relevant vehicle systems can be referred to as being ‘ancillary,’ or an ancillary vehicle system, in various implementations, because the vehicle system is distinct from the primary system or systems—for example, speaker system, display system, or haptic system—by which the customized alert notification are delivered.

In contemplated embodiments, though, the same vehicle system providing the customized alert notifications—via the notification-presentation modules 260, 270—is the same vehicle system that is adjusted via the apparatus-systems-adjustment module 280. As an example, the system adjustment initiated via the vehicle-systems-adjustments module 280 can include lowering a volume of a music signal being provided via the same vehicle speaker system that is used to provide a customized sound notification generated by the deliberation module 230 and delivered for user consumption by way of the sound-delivery module 260.

The system can be configured so that the vehicle automatically adjusts the subject vehicle system(s) or communicates a recommendation that the user adjust the system, such as to roll down the window because a loud construction side is adjacent or being approached.

Example vehicle systems to be selectively adjusted, or recommended for adjustment, include a noise-generating system, such a heating, ventilating, and air-conditioning (HVAC) system of an automobile, or of another apparatus—for example, aircraft, apartment, office, or house. The HVAC generates noise by operation of its fan, for instance, and slowing the fan lowers ambient or environmental noise.

Example vehicle systems can also include, versus a noise-creating system, a noise-allowing or noise-enabling system such as a vehicle window, moon or sunroof, etc. The window allows more noise into the cabin when open.

Example vehicle systems can also include an infotainment component (providing audio/visual entertainment), a navigation component (providing map, routing instructions, traffic, for instance), and a communication component (such as a smartphone). Communication-component and infotainment-component control can include, for instance, lowering volume or changing other sound characteristic of phone output or infotainment system output to promote user appreciation of an alert notification. Navigation-component control can include, for instance, causing presentation of a route change, or an instruction to pull over or slow down.

The deliberation module 230 is configured to determine a manner by which to adjust, via the apparatus-systems-adjustment module 280, the vehicle system to increase a likelihood that a customized and/or base notifications (for example, sound, visual, haptic), determined by the deliberation module 230 (whether using the generation module 250), and provided via the notification-output module(s) 260, 270, will be sensed and appreciated by the user.

The determined vehicle-system adjustment is communicated via path 285. Though the adjustment instruction from the deliberation module 230 can take any of a wide variety of forms, such as a file, packet, message, or instruction, the instruction is referred to below as a ‘system-adjustment result’ to distinguish the ‘sound file’ and the “other-output instruction” obtained, and for simplicity.

In a contemplated embodiment, the apparatus-system adjustment is determined by the deliberation module 230 based one or more of: the alert condition (from alert-condition input module 210), the context (from the contextual-input module 220), a customized sound determined by the deliberation module, a customized visual notification determined by the deliberation module, a customized haptic notification determined by the deliberation module, a base sound determined by the deliberation module, a base visual notification determined by the deliberation module, a base haptic notification determined by the deliberation module, a situational profile, mentioned above, or parts of such profile.

As with the contextual-sound manager and the other-vehicle notification portions of the deliberation module 230, deliberation-module functionality for determining the system-adjustment result can be based on input data received from the input group 200. The inputs include input alert data from the alert-condition input module 210 and input context data from the contextual-input module 220. The input alert data indicates the existing type of alert condition, such as a disconnected seatbelt, backup proximity, a forward separation (following too close), object entering road, etc. The context data indicates one or more relevant contexts—for example, contextual facts—that can indicate how the vehicle system(s) (for example, HVAC, or windows) should be adjusted to increase the likelihood that the notification(s) will be sensed by the user.

To determine or obtain one or more system-adjustment result, the deliberation module 230 in various embodiments, accesses the database or database module 240 or another database, to obtain at least one customized system-adjustment result (for example, fan setting or fan adjustment instruction) appropriate to the circumstances.

In a contemplated embodiment, the deliberation module 230 determines the situational profile, or indicator representative of the circumstances, based on the input alert data and the contextual input data, and accesses the database module 240 to obtain the customized system-adjustment result corresponding to the situational profile or indicator. The situational profile can be the same as that used to obtain the customized sound file and/or the other-vehicle-outputs instruction, described above. The profile or indicator can include, for instance, data indicating the type of alert and data indicating the context, such as data indicating presence or representing qualities—for example, volume, pitch or frequency, direction, tone, and/or other acoustic characteristics—of a loud ambient or environmental sound, such as a jackhammer hammering at a construction site that the vehicle 10 is passing.

The database module 240 in various embodiments includes one or more data structures configured to facilitate the deliberation module 230 determining the appropriate vehicle-system-adjustment result(s). As an example, the database can include a look-up table, or other array, matrix, or other indexing arrangement, relating various condition sets—such as a condition set including an alert condition and one or more contexts—to a corresponding recommended vehicle-system-adjustment result(s), customized to the circumstances.

In various embodiments, the generation module 250 generates the vehicle-system-adjustment result. In some implementations, the deliberation module 230, as part of generating the customized instruction(s), consults the database module 240. This access can also be considered indicated schematically by reference numeral 255.

The generation module 250 could be configured to consult (again, path 255) the database module 240 to obtain a base instruction(s) (for example, a base vehicle-system-adjustment result result), such as a base instruction that would be used in a conventional system, or that would be used if there was no context data, in connection with the subject alert condition received from the alert-condition input module 210. The deliberation or generation module 230, 250 is in this case configured to then adjust or reconfigure the base instruction(s), associated with the alert condition, based on the context received from the contextual-input module 220, yielding the customized instruction.

In another case, the generation module 250 could be configured to consult (path 255) the database module 240 to obtain reconfiguration data, indicating a manner that a base vehicle-system-adjustment should be adjusted to form the vehicle-system-adjustment result. The generation module 250, in various embodiments of this case, also obtains (path 255) the base instruction from the database module 240 or from another repository. The deliberation module 230 then reconfigures the base vehicle-system-adjustment accordingly, yielding the customized vehicle-system-adjustment result.

The generation module 250 is in some implementations configured to generate the customized vehicle-system-adjustment result without using a base instruction. The generation module 250 could still be configured in these implementations to consult (path 255) the database module 240, such as to obtain one or more vehicle-system-adjustment components, not separately amounting to a base vehicle-system-adjustment, to be used in forming the customized vehicle-system-adjustment instruction.

### V.C. Output Group of the Algorithms

The vehicle 10 can, as mentioned, be configured to generate output configured to best deliver alert notifications to the user, or configured according to a cost-benefit analysis in a preferred manner for reaching the user.

The output can include any combination of customized and base output—such as any combination of a customized sound output, a customized visual output, a customized haptic output, or one of such customized output in combination with another customized output or a base version of one of the others.

### V.C.i. Notification-Presentation Modules

The notification-presentation modules of the output group 204—the sound-notification module 260 and the other-vehicle notification module 270—deliver any customized output, and any basic output that may under the circumstances be provided at the same time, for communication to the user(s) via at least one vehicle interface.

The notification-presentation modules 270, 280 can be referred to by other terms, such as presentation modules, notification modules, or notification-output modules.

As mentioned, any of the modules mentioned herein can be combined or separated, or one can be a part of the other. Any one or more of the sound-presentation file 260 and the other-vehicle-outputs presentation module 270 can, in various implementations, be part of the deliberation module 230, as just an example.

The notification-presentation modules 260, 270 can provide the output by way of the vehicle speaker system, regarding audio output, a vehicle dashboard display, a vehicle central-stack display, and/or a vehicle heads-up display, regarding visual output, and a seat, steering wheel, and/or user wearable (e.g., glasses/goggles/headset) regarding haptic output, for instance. The heads-up display, or other visual display, can include a windshield display, such as a display configured to present an augmented-reality experience for the user. And the heads-up display, or other visual display, can include use of a mobile device, such as a wired or wireless pair of glasses or goggles worn by the user, or other eye wear configured to present an augmented-reality experience for the user. Such eye where could present visual and/or auditory warning information, the visual being via a screen or screens and the auditory being via earbuds or other speaker or sound output component(s). In various embodiments, such headwear could be configured to provide the haptic output reference herein, via a mechanical actuator device implemented in the headwear.

Upon receiving, generating, or otherwise obtaining an appropriate output file, the deliberation module 230 delivers the instructions to the sound-outputs module 260. The transfer is indicated by path 265.

Upon receiving, generating, or otherwise obtaining ab appropriate non-sound output instructions (for visual, haptic, or other non-sound notification output, for instance), the deliberation module 230 delivers the instructions to the other vehicle-outputs module 270. The transfer is indicated by path 275.

### V.C.ii. Vehicle-Systems-Adjustment Module

The vehicle-systems-adjustments module 280, of the output group 204, adjusts, or initiates or recommends adjustment of, one or more vehicle systems according to the corresponding output of the deliberation module 230.

As provided, any of the modules can be combined or separated, or one can be a part of the other. The vehicle-systems-adjustments module 280 can, in various implementations, be part of the deliberation module 230, as an example.

Upon receiving, generating, or otherwise obtaining the customized vehicle-system-adjustment result(s), the deliberation module 230 delivers the result(s) to the vehicle-system-adjustment module 280. The transfer is indicated by path 285.

The vehicle-system-adjustment module 280 adjusts, or initiates or recommends adjustment via the subject vehicle system.

As an example, the deliberation module 230 may instruct the vehicle-systems-adjustments module 280 to partially or fully close one or more of the vehicle windows. The module 280 could be configured to close the windows temporarily, and automatically return the window(s) to its/their original position after the notification is provided, or receipt of the customized notification is confirmed, such as by user input, other user action, or changed circumstances or context. In a contemplated embodiment, though, a window is kept at the new, adjusted, position, until the user initiates window(s) adjustment.

As another example, the deliberation module 230 may instruct the vehicle-systems-adjustments module 280 to turn down a fan of a vehicle HVAC system. The module 280 could be configured to turn down the fan temporarily, and automatically return the fan to the prior state, or to leave the fan at the new, adjusted, state, until the user initiates fan adjustment.

Or the deliberation module 230 can communicate, to the vehicle-systems-adjustments module 280, an instruction causing the module 280 to provide a recommendation message advising the user to adjust the vehicle system (e.g., roll down the window, or turn down the radio).

### VI. Example Use Cases

| Ex. | Alert | | Sound | Other-Output | Vehicle-System |
|---|---|---|---|---|---|
| no. | Condition | Context | Notification | Notification | Adjustment |
| 1 | Seatbelt | 0 < vehicle | Base Sound 1 | Base visual; No | (None) |
| | unbuckled | speed < ⊖₁ | (typical for | haptic | |
| | | | unfastened belt) | | |
| 2 | (same as ex. | ⊖₁ < speed < ⊖₂ | Custom Sound 1, | Enhanced | (None) |
| | no. 1) | | louder than Base | visual (for | |
| | | | Sound 1 | example, | |
| | | | | brighter than | |
| | | | | base); No | |
| | | | | haptic | |
| 3 | (same as 1 ) | ⊖₂ < speed < ⊖₃; | Custom Sound 2, | Further | Turn fan down |
| | | HVAC fan high (sensed | louder and | enhanced visual | by an amount, |
| | | via HVAC or | increased | (for example, | or suggest that |
| | | microphone) | frequency vs. | red vs amber); | user do same |
| | | | Custom Sound 1 | Haptic seat | |
| | | | | bottom low vibe | |
| 4 | (same as 1) | ⊖₃ < speed < ⊖₄ | Custom Sound 3, | Enhanced | (None) |
| | | | louder and | visual (for | |
| | | | increased | example, | |
| | | | frequency vs. | brighter than | |
| | | | Custom Sound 2 | base); Haptic | |
| | | | | seat high vibe | |
| 5 | Insufficient | Radio loud | Base Sound 2 | (None) | Lower radio |
| | forward | | (typical for | | volume, or |
| | separation | | insufficient forward | | suggest that |
| | distance - | | separation) | | user do same |
| | 120 ft @ | | OR | | OR |
| | 60 mph | | Custom Sound 4, | | (None) |
| | | | louder then Base | | |
| | | | Sound 2 | | |
| 6 | (same) - | User partially | Custom Sound 5, | (None) | (None) |
| | 100 ft @ | tone deaf | higher tone vs. | | |
| | 60 mph | | Custom Sound 4 | | |
| 7 | (Same as 6) | Loud music | Custom Sound 6, | (None) | Roll windows |
| | | and windows | louder than | | at least |
| | | down | Custom Sound 5 | | partially up, or |
| | | | | | suggest that |
| | | | | | user do same |
| 8 | (Same as 6) | Apparently | Custom Sound 7, | Haptic steering | Turn on/up |
| | | drowsy driver | louder and higher | wheel low vibe | cool/cold air- |
| | | | tempo than | | conditioning, |
| | | | Custom Sound 5 | | or suggest that |
| | | | | | user do same |
| 9 | (Same as 6) | Ambulance | Custom Sound 8 | Haptic steering | (None) |
| | | passing with | having | wheel high vibe | |
| | | siren | characteristics (for | | |
| | | | example, a | | |
| | | | particular volume, | | |
| | | | a particular high | | |
| | | | pitch) selected to | | |
| | | | overcome and/or | | |
| | | | counter the siren | | |
| 10 | (Same as 6) | Driver | Custom Sound 9, | Haptic steering | (None) |
| | | apparently | louder and higher | wheel high vibe | |
| | | looking away | tempo than | at higher tempo | |
| | | from the road | Custom Sound 6 | | |
| 11 | (Same as 6) | Wet road | (Same as 10) | (Same as 10) | (None) |
| 12 | Low fuel or | Location | Base Sound 3 | Base visual | Lower radio |
| | power (EV, | indicates 3 | (typical for low fuel | | volume, when |
| | HEV) | nearby fuel | or power) | | providing the |
| | | or charge | | | Base Sound 3, |
| | | stations; High | | | or suggest that |
| | | radio volume | | | user do same) |
| 13 | (Same as | Location | Custom Sound 10, | Haptic steering | (None) |
| | 12) | indicates | louder then Base | wheel vibe, | |
| | | nearest | Sound 2 | provided per | |
| | | station is 10 | | pre- | |
| | | miles away | | programming | |
| | | | | configured to | |
| | | | | cause desired | |
| | | | | user reaction - | |
| | | | | such as driving | |
| | | | | to nearest | |
| | | | | station | |
| | | | | immediately | |
| | | | | (e.g., fast tempo | |
| | | | | vibrations in | |
| | | | | repeating | |
| | | | | windows of time | |
| | | | | separated by | |
| | | | | brief times of no | |
| | | | | vibration); High | |
| | | | | level visual - | |
| | | | | for instance, | |
| | | | | bright, located | |
| | | | | in HUD to | |
| | | | | increase | |
| | | | | likelihood of | |
| | | | | being seen, and | |
| | | | | in a high- | |
| | | | | conspicuous | |
| | | | | color, such as | |
| | | | | red vs amber | |

### VI. Select Advantages

Many of the benefits and advantages of the present technology are described above. The present section restates some of those and references some others. The benefits described are not exhaustive of the benefits of the present technology.

Customized notifications provided by the present technology are more likely to be sensed and appreciated by a user, being determined, based on any of various contextual situations, as the best manner to best deliver the notification, or preferred manner according to a cost-benefit analysis.

The technology enables better management of user attention, including to promote safety, driving experience, and satisfaction, and perhaps therein promote vehicle use generally.

In various embodiments, new sounds are generated sounds using base or standard sounds, not from scratch, saving cost and data-processing and data-storage requirements.

Also by using base files, such as a base sound file, altered files—e.g., customized sound—will be recognizable by the user, though being adjusted to increase the likelihood of being perceived by the user.

### VII. Conclusion

Various embodiments of the present disclosure are disclosed herein. The disclosed embodiments are merely examples that may be embodied in various and alternative forms, and combinations thereof.

The above-described embodiments are merely exemplary illustrations of implementations set forth for a clear understanding of the principles of the disclosure.

References herein to how a feature is arranged can refer to, but are not limited to, how the feature is positioned with respect to other features. References herein to how a feature is configured can refer to, but are not limited to, how the feature is sized, how the feature is shaped, and/or material of the feature. For simplicity, the term configured can be used to refer to both the configuration and arrangement described above in this paragraph.

References herein indicating direction are not made in limiting senses. For example, references to upper, lower, top, bottom, or lateral, are not provided to limit the manner in which the technology of the present disclosure can be implemented. While an upper surface may be referenced, for example, the referenced surface need not be vertically upward, in a design, manufacture, or operating reference frame, or above any other particular component, and can be aside of some or all components in design, manufacture and/or operation instead, depending on the orientation used in the particular application.

Directional references are provided herein mostly for ease of description and for simplified description of the example drawings, and the thermal-management systems described can be implemented in any of a wide variety of orientations. References herein indicating direction are not made in limiting senses. For example, references to upper, lower, top, bottom, or lateral, are not provided to limit the manner in which the technology of the present disclosure can be implemented. While an upper surface is referenced, for example, the referenced surface can, but need not be vertically upward, or atop, in a design, manufacturing, or operating reference frame. The surface can in various embodiments be aside or below other components of the system instead, for instance.

Any component described or shown in the figures as a single item can be replaced by multiple such items configured to perform the functions of the single item described. Likewise, any multiple items can be replaced by a single item configured to perform the functions of the multiple items described.

Variations, modifications, and combinations may be made to the above-described embodiments without departing from the scope of the claims. All such variations, modifications, and combinations are included herein by the scope of this disclosure and the following claims.

1.-13. (canceled)

14. A non-transitory computer-readable storage device comprising a module configured to, when executed by a hardware-based processing unit:
obtain notification-response data indicating how a vehicle user responded to prior presentation of a past notification to alert the vehicle user of a past alert condition;
obtain present alert-condition input data indicating a present alert condition present at an apparatus;
determine that the present alert condition is equivalent or similar to the past alert condition, yielding a common-alert-condition determination; and
determine, based on the notification-response data and the common-alert-condition determination, a manner by which to modify the cast notification, or determine, or a present notification distinct from the past notification, yielding a customized alert notification for being delivered by a tangible interface to notify the vehicle user of the present alert condition in a manner distinct from a manner of the past notification in effort to improve the likelihood that the vehicle user will act appropriately concerning the present alert condition.

15.-20. (canceled)

21. The non-transitory computer-readable storage device of claim 14, wherein the notification-response data indicates that the vehicle user either did not respond to the past notification or did not respond appropriately to the past notification.

22. The non-transitory computer-readable storage device of claim 14, wherein the notification-response data indicates that the vehicle user responded too slowly to the past notification.

23. The non-transitory computer-readable storage device of claim 14, wherein the present notification differs from the past notification at least by location from which the notification is presented.

24. The non-transitory computer-readable storage device of claim 14, wherein the present notification differs from the past notification at least by modality from which the notification is presented.

25. The non-transitory computer-readable storage device of claim 14, wherein the past notification was multi-modal using a first group of communication modes and the customized alert notification is multi-modal using a difference group of communication modes.

26. The non-transitory computer-readable storage device of claim 25, wherein the first group and the second group have at least one mode in common.

27. The non-transitory computer-readable storage device of claim 14, wherein the past notification was single-modal and the customized alert notification is multi-modal.

28. The non-transitory computer-readable storage device of claim 14, wherein the module is configured to, when executed by the hardware-based processing unit, establish a system-user profile comprising a preference including the customized alert notification in association with the present alert condition.

29. A non-transitory computer-readable storage device comprising a module configured to, when executed by a hardware-based processing unit:
obtain notification-response data indicating how a vehicle user responded to prior presentation of a past notification to alert the vehicle user of a past alert condition;
obtain past environmental context data indicating a past environmental context existing before or during the past alert condition;
obtain present alert-condition input data indicating a present alert condition present at an apparatus;
obtain present environmental context input data indicating a present environmental context;
determine that the present alert condition is equivalent or similar to the past alert condition and/or that the present environmental context is equivalent to or similar to the past environmental context, yielding a commonality determination; and
determine, based on the notification-response data and the common-alert-condition determination, a manner by which to modify the past notification, or determine, or a present notification distinct from the past notification, yielding a customized alert notification for being delivered by a tangible interface to notify the vehicle user of the present alert condition in a manner distinct from a manner of the past notification in effort to improve the likelihood that the vehicle user will act appropriately concerning the present alert condition.

30. The non-transitory computer-readable storage device of claim 29 wherein both the past environmental condition and the present environmental condition relate to a characteristic selected from a group of characteristics consisting of:
cabin noise level;
cabin noise quality; and
a weather condition.

31. The non-transitory computer-readable storage device of claim 29, wherein the notification-response data indicates that the vehicle user either did not respond to the past notification or did not respond appropriately to the past notification.

32. The non-transitory computer-readable storage device of claim 29, wherein the notification-response data indicates that the vehicle user responded too slowly to the past notification.

33. The non-transitory computer-readable storage device of claim 29, wherein the present notification differs from the past notification at least by location from which the notification is presented.

34. The non-transitory computer-readable storage device of claim 29, wherein the present notification differs from the past notification at least by modality from which the notification is presented.

35. The non-transitory computer-readable storage device of claim 29, wherein the past notification was multi-modal using a first group of communication modes and the customized alert notification is multi-modal using a difference group of communication modes.

36. The non-transitory computer-readable storage device of claim 29, wherein the past notification was single-modal and the customized alert notification is multi-modal.

37. The non-transitory computer-readable storage device of claim 29, wherein the module is configured to, when executed by the hardware-based processing unit, establish a system-user profile comprising a preference including the customized alert notification in association with the present alert condition and/or the present environmental context.

38. A non-transitory computer-readable storage device comprising a module configured to, when executed by a hardware-based processing unit:
obtain alert-condition input data indicating an alert condition present at a vehicle;
obtain environmental context input data indicating a local component of the apparatus creating, during the alert condition, a noise that is or may be distracting a vehicle user; and
determine, based on the alert-condition input data and the environmental context input data, a manner by which to adjust the local component to reduce an amount noise produced by the apparatus component to improve the likelihood that the vehicle user will act appropriately concerning the alert condition.

39. The non-transitory computer-readable storage device of claim 38 wherein the apparatus the local component is selected from a group of components consisting of:
a heating, ventilating, and air-conditioning component;
an adjustable-window component;
an infotainment component;
a navigation component; and
a communication component.
